(19) United States
(12) Patent Application Publication
(10) Pub. No.: US 2009/0303379 A1
(43) Pub. Date: Dec. 10, 2009

(54) IMAGE PICKUP DEVICE DRIVING APPARATUS AND IMAGING APPARATUS USING THE SAME

(76) Inventors: Jouji Wada, Kanagawa (JP); Shokichi Takahashi, Tokyo (JP); Masami Takahashi, Kanagawa (JP); Nobuhito Seki, Tokyo (JP)

Correspondence Address: RATNERPRESTIA, P.O. BOX 980, VALLEY FORGE, PA, 19482, US

(21) Appl. No.: 11/915,902

(22) PCT Filed: Jun. 15, 2006
(86) PCT No.: PCT/JP2006/311987

§ 371 Date: Nov. 29, 2007

(30) Foreign Application Priority Data
Jun. 24, 2005 (JP) 2005-184308

(51) Int. Cl. H04N 5/225

(52) U.S. Cl. 348/373; 348/E05.024

(57) ABSTRACT

An image pickup device driving apparatus includes: an image pickup device holder that holds an image pickup device, with an image pickup surface of the image pickup device directing to a predetermined direction, and is movable in a direction of optical axis; a movable unit that is provided to contact the image pickup device holder; a driving unit that moves the image pickup device held by the image pickup device holder in the direction of optical axis by driving the movable unit, with a surface direction of the image pickup surface unchanged; and a position holding power providing member that provides position holding power to hold a position of the image pickup device holder in the direction of the optical axis, and an imaging apparatus using the same.

### TECHNICAL FIELD

The present invention relates to an imaging apparatus such as a monitoring camera apparatus or a video camera apparatus, and more particularly, to an image pickup device driving apparatus for moving the image pickup device in an optical axis direction of a lens, and an imaging apparatus using the same.

### BACKGROUND ART

To begin with, a conventional technique for an imaging apparatus will be described. Here, a monitoring camera apparatus will be described as an example of the imaging device.

In recent years, there have been proposed techniques regarding various monitoring camera apparatuses. In particular, there have been proposed techniques regarding the monitoring camera apparatuses for monitoring during the day and night in which, during the day, visible light is selectively transmitted and an infrared cut filter for absorbing an infrared ray is arranged in the front side of an image pickup device, and at night, the infrared cut filter arranged in the front side of the image pickup device is detached from the image pickup to allow an infrared ray to enter the image pickup device, thereby increasing night imaging sensitivity and hence night monitoring precision.

In the aforementioned monitoring camera apparatus, in a case where a photograph is taken with a visible ray and a case where a photograph is taken with an infrared ray, there arises a problem in that length of an optical path is varied due to wavelength deviation or the like of a light ray used for photographing depending on conditions on presence of the infrared cut filer, illumination and the like, and for example. In addition, in a case where a photograph is taken at night with an infrared ray with optimized length of an optical path at photographing with a visible ray during the day, there arises a problem in that an image obtained by the photographing becomes dim.

To solve the above problems, there has been for example proposed an imaging apparatus which is capable of manually adjusting a position of an image pickup device in an optical axis direction as necessary. An example of the method of adjusting the position of the image pickup device in the optical axis direction may include a method of adjusting a position of an image pickup device in an optical axis direction by biasing the image pickup device in one direction by means of an elastic member while keeping the image pickup device movable in the optical axis direction and pressing the image pickup device in an opposite direction by rotating a adjustment ring having a cam mechanism (for example, see Japanese Unexamined Patent Application Publication No. 2000-165733).

In addition, in recent years, there has been proposed a surveillance camera apparatus which is capable of obtaining a sharp image in focus irrespective of day or night by correcting a focus length difference due to an optical path difference at photographing with a visible ray and a ray from a region including a visible ray and an infrared ray by moving an image pickup device to a position having the highest focusing value in an optical axis direction while referring to focusing values of an image signal output from the image pickup device when an infrared cut filter is arranged on and removed from an optical path (for example, see Japanese Unexamined Patent Application Publication No. 2003-274229).

In such a surveillance camera apparatus, a lead screw is used to move the image pickup device, a nut part is provided to be rotated around the lead screw, the image pickup device is attached to a chassis whose operation is limited in the optical axis direction by a guide rod, and the lead screw is rotated by a stepping motor. With this configuration, by rotating the lead screw by rotation of the stepping motor, it is possible to move the image pickup device by a desired distance in the optical axis direction.

However, in the surveillance camera apparatus disclosed in Japanese Unexamined Patent Application Publication No. 2003-274229, the image pickup device is moved when the chassis, which includes the image pickup device and is supported by two axes, i.e., the lead screw and the guide rod, is moved in the optical axis direction. Accordingly, this apparatus has a problem in that its structure becomes large in the optical axis direction since it has to have the two axes and thereby the apparatus is reduced in the size with difficulty.

In addition, as disclosed in Japanese Unexamined Patent Application Publication No. 2000-165733, it may also be considered to rotate the adjustment ring having the cam mechanism using the motor or the like and control a driving controller to detect a position having the highest focusing value and stop the adjustment ring at the position to adjust a position of the image pickup device in the optical axis direction. Although this configuration solves the problem that the structure becomes large in the optical axis, the technique disclosed in Japanese Unexamined Patent Application Publication No. 2000-165733 is to design a biasing force of the elastic member for basing the image pickup device to the adjustment ring such that the image pickup device is not largely moved by a weak force, that is, a torque required to rotate the adjustment ring manually becomes large. In the mean time, the image pickup device has to be smoothly moved in order to successively detect focusing values while moving the image pickup device in the optical axis direction and move the image pickup device to the position having the highest focusing value. However, since the image pickup device is biased to the adjustment ring by a strong force, a high capacity motor is required to rotate the adjustment ring and it is difficult to smoothly move the image pickup device with a relatively weak driving force by a small capacity motor.

On the other hand, if a torque required to rotate the adjustment ring becomes small to smoothly move the image pickup device in the optical axis direction, the adjustment ring may be rotated when an external force such as impact is applied to the image pickup device, thereby making it difficult to hold a stop position of the image pickup device at a desired position.

### DISCLOSURE OF THE INVENTION

It is therefore an object of the invention to provide an image pickup device driving apparatus which is capable of smoothly moving an image pickup device in an optical axis direction even by a relatively weak driving force and stopping the image pickup device at a desired position even when an external force such as impact is applied to the image pickup device, and an imaging apparatus using the same.

In order to achieve the above-mentioned object, according to an aspect of the invention, there is provided an image pickup device driving apparatus including: an image pickup device holder that holds an image pickup device, with an image pickup surface of the image pickup device directing to a predetermined direction, and is movable in a direction of optical axis; a movable unit that is provided to contact the image pickup device holder; a driving unit that moves the image pickup device held by the image pickup device holder in the direction of optical axis by driving the movable unit, with a surface direction of the image pickup surface unchanged; and a position holding power providing member that provides position holding power to hold a position of the image pickup device holder in the direction of optical axis.

With this configuration, even when the movable unit is operated with a relatively small torque for smoothly moving the image pickup device, since the image pickup device can be stopped at an accurate position in the direction of optical axis of the image pickup device, it is possible to smoothly move the image pickup device in the direction of optical axis even with a relatively weak driving force. In addition, since the position holding power providing member that provides the position holding power to hold the position of the image pickup device holder in the direction of optical axis is separately arranged, it is possible to realize an image pickup device driving apparatus which is capable of stopping the image pickup device at a desired position even when an external force such as impact is applied to the image pickup device.

Preferably, the image pickup device holder includes three projections on a surface facing the removable unit, the removable unit includes three slopes on a surface facing the image pickup device holder, the three slopes contacting the three projections of the image pickup device holder respectively, and the image pickup device is moved in the direction of optical axis as a distance in the direction of optical axis between the image pickup device holder and the movable unit is changed when the driving unit moves the movable unit.

With this configuration, since the three projections of the image pickup device holder move the image pickup device in the direction of optical axis in contact with the three slopes of the movable unit, it is possible to prevent a tilt angle from occurring.

Preferably, the driving unit is a stepping motor, and the position holding power providing member is a magnetic core position fixing member that fixes a position of a magnetic core in the stepping motor.

With this configuration, it is possible to provide a simple configuration that the stepping motor is used as the driving unit.

Preferably, the position holding power providing member is a movable unit stopper that stops operation of the movable unit mechanically.

With this configuration, it is possible to reliably stop the image pickup device at an accurate position by stopping operation of the movable unit mechanically.

Preferably, the position holding power providing member is an image pickup device holder stopper that stops movement of the image pickup device holder in the direction of optical axis.

With this configuration, it is possible to reliably stop the image pickup device at an accurate position by stopping movement of the image pickup device holder.

Preferably, the image pickup device driving apparatus further includes an elastic member that biases the image pickup device holder toward one of the direction of optical axis, and the movable unit applies a biasing force to the image pickup device holder in a direction opposite to the one of the direction of optical axis.

With this configuration, it is possible to move the image pickup device more smoothly.

Preferably, the movable unit has a shaft provided in the direction of optical axis and is axially and rotatably supported by the shaft, and the driving unit changes the distance between the movable unit and the image pickup device holder by rotating the movable unit to change positions at which the three projections contact the three slopes.

With this configuration, since the movable unit axially supported by the shaft provided in the direction of optical axis is used, it is possible to realize a compact configuration in the direction of optical axis.

Preferably, the driving unit is a rotary motor.

With this configuration, it is possible to realize a simple configuration by using the rotary motor.

Preferably, the driving unit has a worm gear that rotates the movable unit.

With this configuration, it is possible to rotate the movable unit smoothly.

Preferably, the worm gear has a two or more-line screw.

With this configuration, since the worm gear can be rotated by rotating the movable unit, it is possible to rotate the movable manually.

Preferably, the driving unit has a parallel axis saw-toothed wheel that rotates the movable unit.

With this configuration, it is possible to realize a simple configuration.

Preferably, the driving unit has a helical gear that rotates the movable unit.

With this configuration, it is possible to rotate the movable unit smoothly.

Preferably, a slip plate is interposed between the parallel axis saw-toothed wheel and the rotary motor.

With this configuration, it is possible to rotate the movable unit manually to move the image pickup device.

Preferably, the movable unit has a knob that rotates the movable unit manually.

With this configuration, it is possible to rotate the movable unit manually with ease.

Preferably, the driving unit is a direct-driven motor.

With this configuration, it is possible to raise a degree of freedom in arrangement of the driving unit.

Preferably, a driving direction changing member that changes a driving direction is interposed between the direct-driven motor and the movable unit.

With this configuration, it is possible to arrange the driving unit at a desired position by changing the driving direction.

Preferably, the movable unit is movable in a direction perpendicular to the direction of optical axis, and the driving unit changes the distance between the movable unit and the image pickup device holder by moving the movable unit in the direction perpendicular to the direction of optical axis to change positions at which the three projections contact the three slopes.

With this configuration, since the three projections of the image pickup device holder move the image pickup device in the direction of optical axis in contact with the three slopes of the movable unit, it is possible to prevent a tilt angle from occurring.

Preferably, the driving unit is a direct-driven motor.

With this configuration, it is possible to raise a degree of freedom in arrangement of the driving unit.

According to another aspect of the invention, there is provided an imaging apparatus including: a lens unit; an image pickup device; the above-described image pickup device driving apparatus, and an image signal processing unit that performs an image signal process for a signal outputted from the image pickup device.

With this configuration, even when the movable unit is operated with a relatively small torque for smoothly moving the image pickup device, since the image pickup device can be stopped at an accurate position in the direction of optical axis, it is possible to smoothly move the image pickup device in the direction of optical axis even with a relatively weak driving force. In addition, since the position holding power providing member that provides the position holding power to hold the position of the image pickup device holder in the direction of optical axis is separately arranged, it is possible to realize an imaging apparatus which is capable of stopping the image pickup device at a desired position even when an external force such as impact is applied to the image pickup device.

As described above, the invention provides an image pickup device driving apparatus which is capable of smoothly moving an image pickup device in an optical axis direction even by a relatively weak driving force and stopping the image pickup device at a desired position even when an external force such as impact is applied to the image pickup device, and an imaging apparatus using the same.

### BRIEF DESCRIPTION OF THE DRAWINGS

FIG. 1 is an exploded perspective view showing a configuration of an imaging apparatus according to a first embodiment of the invention.

FIG. 2 is a block diagram showing a configuration of a main functional block of an imaging apparatus according to the first embodiment of the invention.

FIG. 3A is a side view of an image pickup device driving apparatus of the imaging apparatus according to the first embodiment of the invention.

FIG. 3B is a rear view of the imaging apparatus, which is used to explain an image pickup device driving apparatus of the imaging apparatus according to the first embodiment of the invention.

FIG. 3C is a sectional view taken along arrow AB of FIG. 3A, showing a configuration of an image pickup device driving apparatus of the imaging apparatus according to the first embodiment of the invention.

FIG. 4 is an exploded perspective view showing a configuration of an imaging apparatus according to a second embodiment of the invention.

FIG. 5 is a view showing a configuration of a driving unit mounted in the imaging apparatus according to the second embodiment of the invention.

FIG. 6 is a view showing a configuration of an image pickup device driving apparatus according to a third embodiment of the invention.

FIG. 7 is a view showing a configuration of an image pickup device driving apparatus according to a fourth embodiment of the invention.

FIG. 8 is a view showing a configuration of an image pickup device driving apparatus according to a fifth embodiment of the invention.

FIG. 9A is a front perspective view showing a configuration of an image pickup device driving apparatus according to a sixth embodiment of the invention.

FIG. 9B is a rear perspective view showing a configuration of the image pickup device driving apparatus according to the sixth embodiment of the invention.

FIG. 10 is a view showing a configuration of an image pickup device driving apparatus according to a seventh embodiment of the invention.

FIG. 11A is a front (lens side) perspective view showing a configuration of an image pickup device driving apparatus according to an eighth embodiment of the invention.

FIG. 11B is a rear perspective view showing a configuration of the image pickup device driving apparatus according to the eighth embodiment of the invention.

FIG. 12A is a view showing a configuration of an image pickup device driving apparatus and a configuration of an imaging apparatus using the same according to a ninth embodiment of the invention.

FIG. 12B is a view showing a configuration of an image pickup device driving apparatus and a configuration of an imaging apparatus using the same according to a ninth embodiment of the invention.

### DESCRIPTION OF REFERENCE NUMERALS AND SIGNS

1, 101, 801: IMAGING APPARATUS
2, 102: LENS MOUNT
3, 103, 203, 303, 403, 503, 603, 703, 803: MOVABLE UNIT
4, 204, 404, 504, 604, 704, 804: BASE
5: IMAGE PICKUP DEVICE HOLDER
7: THROUGH HOLE
9, 809: SLOPE
11, 810: ELASTIC MEMBER
12: KNOB
15: IMAGE PICKUP DEVICE
20, 120, 220, 420, 620, 820: DRIVING UNIT
21, 127, 223, 621, 821: SHAFT
22, 125: GEAR
23, 323: FEMALE SCREW
30: IMAGE SIGNAL PROCESSING UNIT
31: CONCAVE PORTION
32, 232: SAW-TOOTHED PORTION
40: FOCUSING VALUE CALCULATING UNIT
41: SHAFT
44: MOUNT
45: PROJECTION
48: HOLDING AXIS
49, 61, 605: BEARING
50: CONTROLLER
51: BOSS
60: OUTPUT UNIT
70, 170, 270, 370, 470, 570, 670, 770, 870: IMAGE PICKUP DEVICE DRIVING APPARATUS
71: SPRING HOLDER
83: IMAGE PICKUP SURFACE
104: SLIT
121: SLIP PLATE
122: SLIP RECEIVING PART
123, 201, 202, 903: SCREW
124: FRICTION MATERIAL
126: HELICAL SPRING
128: SPRING FIXING MEMBER
129: STEPPING MOTOR
191: LENS UNIT
221, 321: WORM GEAR
222: HOLDER
322, 422, 522, 689, 722: PROJECTION
405: ELASTIC MEMBER
408, 607, 608: SHAFT
409, 508: PRESSING MEMBER
510, 710: MANUAL MOVABLE UNIT
606: DRIVING DIRECTION CHANGING MEMBER
622: ATTACHING MEMBER
822: BIASING FORCE TRANSMITTING MEMBER
921: MALE SCREW

### PREFERRED EMBODIMENTS FOR CARRYING OUT THE INVENTION

Hereinafter, preferred embodiments of the invention will be described with reference to the accompanying drawings.

### First Embodiment

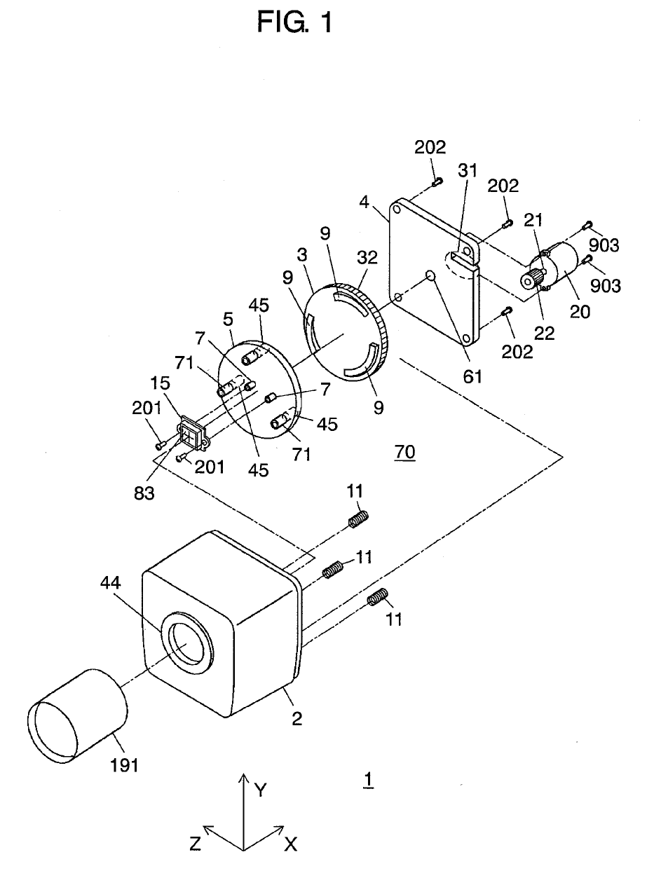

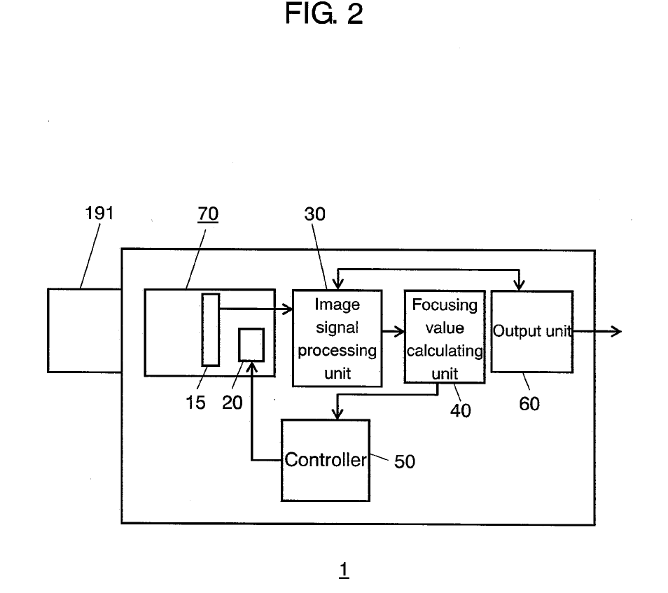

To begin with, a configuration of imaging apparatus 1 according to a first embodiment of the invention will be described. FIG. 1 is an exploded perspective view showing a configuration of imaging apparatus 1 according to a first embodiment of the invention. FIG. 2 is a block diagram showing a configuration of a main functional block of the imaging apparatus 1 according to the first embodiment of the invention. In embodiments of the invention, for the purpose of simplification of description, X, Y and Z axes, which are orthogonal to each other, are depicted in figures showing mechanical structures. The X axis is in parallel to an optical axis of a lens unit, and the Y and Z axes are perpendicular to the optical axis. In embodiments of the invention, for the purpose of avoiding complexity of description, detailed parts such as small screws may not be shown in figures throughout.

Referring to FIG. 1, imaging apparatus 1 according to the first embodiment of the invention includes lens mount 2 having mount 44 on which lens unit 191 is mounted, and image pickup device driving apparatus 70 which is mounted on lens mount 2. Image pickup device driving apparatus 70 includes image pickup device holder 5 for holding image pickup device (an imaging device known in the art, such as a CCD or a CMOS sensor) 15; driving unit 20; base 4 for holding driving unit 20; and movable unit 3. Image pickup device holder 5 moves image pickup device 15 along the X axis, with its image pickup surface 83 perpendicular to an optical axis of lens unit 191. Movable unit 3 is supported by shaft 41 (not shown in FIG. 1) with respect to base 4 and varies a distance from image pickup device holder 5 along the optical axis (X axis) by being rotated by actuation of driving unit 20, with the optical axis as a rotational axis. Detailed structure of image pickup device driving apparatus 70 will be described later.

Referring to FIG. 2, imaging apparatus 1 according to the first embodiment of the invention includes image signal processing unit 30 that performs an image signal process for an electrical signal outputted from image pickup device 15; focusing value calculating unit 40 that accumulates values of predetermined frequency components (high frequency components) from an image signal outputted from image signal processing unit 30 and calculates a resultant value of the accumulation as a focusing value; and controller 50 that controls driving unit 20 of image pickup device driving apparatus 70 to adjust an optical axis of image pickup device 15 to a position at which the focusing value calculated in focusing value calculating unit 40 is most likely to be the highest value. The image information is outputted from image signal processing unit 30 to the outside of imaging apparatus 1 via output unit 60. In this manner, in imaging apparatus 1 according to the first embodiment of the invention, driving unit 20 can automatically move the optical axis of image pickup device 15 to the position at which the focusing value is most likely to be the highest value, it is possible to obtain a sharp image in focus at all times. In addition, it is possible to output the calculated focusing value from focusing value calculating unit 40 to the outside via output unit 60 and control controller 50 using an external device by referring to the output focusing value.

Now, the configuration of image pickup device driving apparatus 70 in the first embodiment of the invention will be described in more detail.

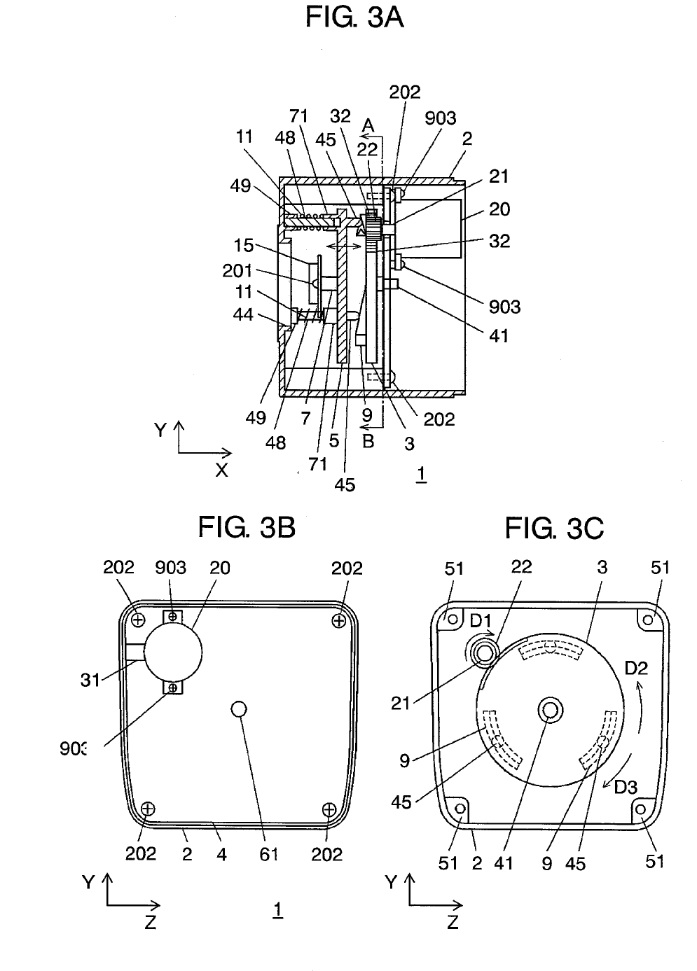

FIGS. 3A to 3C are views showing the configuration of image pickup device driving apparatus 70 of imaging apparatus 1 according to the first embodiment of the invention: FIG. 3A being a side view of image pickup device driving apparatus 70; FIG. 3B being a rear view of imaging apparatus 1; and FIG. 3C being a sectional view taken along arrow AB of FIG. 3A.

Referring to FIGS. 1 and 3A, in image pickup device driving apparatus 70 mounted on imaging apparatus 1 in the first embodiment of the invention, disc-like image pickup device holder 5 includes through holes 7 which are provided at a side of lens unit 191 and to which image pickup device 15 is attached by means of screws 201; spring holders 71 connected to lens mount 2 by means of elastic member 11; and three projections 45 provided at a side opposite to the side of lens unit 191 (a side facing movable unit 3). Three projections 45 are equal in height and are arranged at positions to form an equilateral triangle at equal distances from the optical axis when image pickup device driving apparatus 70 is constructed.

In image pickup device driving apparatus 70 mounted on imaging apparatus 1 in the first embodiment of the invention, disc-like movable unit 3 includes three slopes 9 arranged respectively to face three projections 45 of image pickup device holder 5; circumferential saw-toothed portion 32; and shaft 41 arranged as a rotational axis at a side facing base 4. Three slopes 9 has the same shape and are arranged at equal distances from a rotation center of shaft 41 on a circumference. In addition, as shown in FIGS. 1 and 3C, three slopes 9 are arranged to increase in height in a clockwise direction in FIG. 3C (indicated by arrow D3 in FIG. 3C).

In image pickup device driving apparatus 70 mounted on imaging apparatus 1 in the first embodiment of the invention, base 4 includes bearing 61 that receives shaft 41 of movable unit 3; and concave portion 31 to which driving unit 20 is attached by means of screw 903. In the first embodiment of the invention, it is preferable that movable unit 3 is attached to base 4 so that movable unit 3 can be smoothly rotated with a relatively small torque to base 4 by means of driving unit 20 having relatively small power.

In image pickup device driving apparatus 70 mounted on imaging apparatus 1 in the first embodiment of the invention, driving unit 20 includes gear 22 formed to engage with circumferential saw-toothed portion 32 of movable unit 3; and shaft 21 that axially supports gear 22. In the first embodiment of the invention, since a lockable rotary stepping motor is used as driving unit 20, driving unit 20 may have a magnetic core position fixing member (not shown), serving as a position holding power providing member to provide position holding power to hold a position of the image pickup device holder in the direction of optical axis, that can provide a so-called detent torque by stopping rotation of a magnetic core at any position.

Now, a method of mounting image pickup device driving apparatus 70 on lens mount 2 in imaging apparatus 1 in the first embodiment of the invention will be described. Referring to FIG. 3A, in imaging apparatus 1 in the first embodiment of the invention, three bearings 49 are arranged in an inner side of lens mount 2 on a surface on which mount 44 to which lens unit 191 is attached is mounted, holding axes 48 are respectively erected on three bearings 49, and spring holders 71 of image pickup device holder 5 are connected, via elastic member 11, to a side opposite to a side connected to three bearings 49 of holding axes 48. Accordingly, image pickup device holder 5 remains biased toward the optical axis (X axis direction) by elastic member 11.

Referring to FIGS. 1, 3A and 3C, in image pickup device driving apparatus 70 of imaging apparatus 1 in the first embodiment of the invention, base 4 to which movable unit 3 is attached is attached to boss 51 of lens mount 2 by means of screws 202. Accordingly, in image pickup device driving apparatus 70 of imaging apparatus 1 in the first embodiment of the invention, since movement of movable unit 3 in the direction of optical axis is restricted, it can be said that image pickup device holder 5 is biased to movable unit 3.

With the above configuration, as shown in FIG. 3C, in image pickup device driving apparatus 70 of imaging apparatus 1 in the first embodiment of the invention, three projections 45 arranged in image pickup device holder 5 is keeps contact with three slopes 9 arranged in movable unit 3. driving unit 20 is arranged in base 4 so that gear 22 of driving unit 20 engages with circumferential saw-toothed portion 32 of movable unit 3.

In order that image pickup device driving apparatus 70 of imaging apparatus 1 in the first embodiment of the invention moves image pickup device 15 in the direction of optical axis of lens unit 191, controller 50 instructs driving unit 20 to rotate gear 22 of driving unit 20. In FIG. 3C, for example, when gear 22 of driving unit 20 is rotated in a clockwise direction (indicated by direction D1 in FIG. 3C), movable unit 3 is rotated in a counterclockwise direction (indicated by direction D2 in FIG. 3C). With such rotation, since three projections 45 of image pickup device holder 5 contact higher portions of three slopes 9 arranged in movable unit 3, movable unit 3 becomes more distant from image pickup device holder 5, and as a result, image pickup device 15 moves in a direction opposite to the direction of optical axis (i.e., −X axis direction). At this time, since three projections 45 contact portions having the same height of three slopes 9 of movable unit 3, image pickup device 15 can move in the direction of optical axis as is originally set without being deviated from the direction of optical axis.

On the other hand, in image pickup device driving apparatus 70 of imaging apparatus 1 in the first embodiment of the invention, when image pickup device 15 is to move in the direction of optical axis (X axis direction), controller 50 instructs driving unit 20 to rotate gear 22 of driving unit 20 in a counterclockwise direction in FIG. 3C (indicated by direction D2 in FIG. 3C). In FIG. 3C, for example, when gear 22 of driving unit 20 is rotated in the counterclockwise direction, movable unit 3 is rotated in the clockwise direction (indicated by direction D1 in FIG. 3C). With such rotation, since three projections 45 of image pickup device holder 5 contact lower portions of three slopes 9 arranged in movable unit 3, movable unit 3 becomes closer to image pickup device holder 5, and as a result, image pickup device 15 moves in the direction of optical axis (i.e., X axis direction). When moving smoothly of image pickup device 15 is desired, using a helical gear as gear 22 of driving unit 20 makes it possible to move image pickup device 15 more smoothly.

As described above, using image pickup device driving apparatus 70 and imaging apparatus 1 using the same in the first embodiment of the invention makes it possible to automatically move image pickup device 15 in the direction of optical axis through a simple configuration that driving unit 20 rotates movable unit 3, with a surface direction of image pickup surface 83 of image pickup device 15 unchanged.

If the rotation of movable unit 3 is to be stopped at a desired position, like the above, a stepping motor as driving unit 20 may be used to stop a magnetic core at a desired position, or a movable unit stopping unit such as a plunger as a separate mechanical position holding power providing member may be used to stop the rotation of movable unit 3, or image pickup device 15 may be stopped at any positions in the direction of optical axis by stopping movement of image pickup device holder 5 using an image pickup device holder stopper such as a plunger.

### Second Embodiment

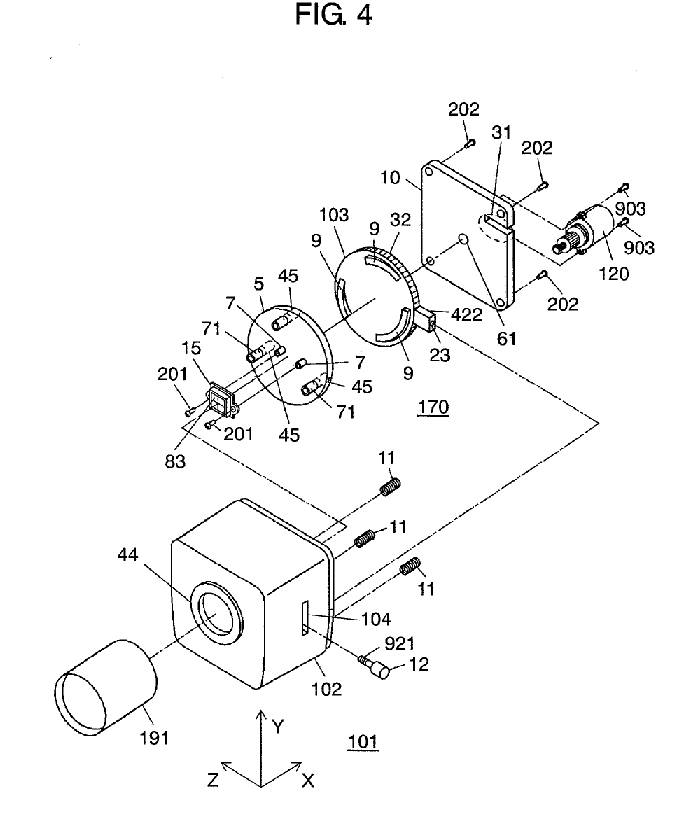

Next, configuration of image pickup device driving apparatus 170 and imaging apparatus 101 according to a second embodiment of the invention will be described. FIG. 4 is an exploded perspective view showing a configuration of imaging apparatus 101 according to the second embodiment of the invention, and FIG. 5 is a view showing a configuration of driving unit 120 mounted on imaging apparatus 101 according to the second embodiment of the invention.

Image pickup device driving apparatus 170 and imaging apparatus 101 using the same in the second embodiment of the invention use driving unit 120 to automatically move image pickup device 15 in the direction of optical axis, like image pickup device driving apparatus 70 and imaging apparatus 1 using the same in the first embodiment, while manually move image pickup device 15 in the direction of optical axis.

Image pickup device driving apparatus 170 and imaging apparatus 101 using the same in the second embodiment of the invention are different from image pickup device driving apparatus 70 and imaging apparatus 1 using the same in the first embodiment of the invention in that the former includes knob 12 having male screw 921 for manually rotating movable unit 103, projection 422 having female screw 23 which is formed at one end on the circumference of movable unit 103 and engages with male screw 921 of knob 12, and slip plate 121 as driving unit 120. Referring to FIG. 4, in image pickup device driving apparatus 170 and imaging apparatus 101 in the second embodiment of the invention, knob 12 rotating movable unit 103 is attached to movable unit 103 from the outside of a case via slit 104 provided in lens mount 102. Other components common to image pickup device driving apparatus 70 and imaging apparatus 1 in the first embodiment of the invention are denoted by like reference numerals, and explanation thereof will be omitted.

Referring to FIG. 5, in image pickup device driving apparatus 170 and imaging apparatus 101 in the second embodiment of the invention, stepping motor 129 is used as a motor of driving unit 120, and has, on its shaft 127, slip plate 121 which is biased toward one direction (X axis direction in FIG. 5) by helical spring 126, has gear 125 as a parallel axis saw-toothed wheel, and can rotate around shaft 127, and slip receiving part 122 which faces slip plate 121 and joins shaft 127 by means of screw 123. Since one end of helical gear spring 126 is fixed by spring fixing member 128 arranged in one end of shaft 127, slip plate 121 is biased toward a direction indicated by an arrow in FIG. 5 (right direction). Concentric unevenness is formed on a surface facing slip receiving part 122 of slip plate 121 and a surface facing slip plate 121 of slip receiving part 122, and friction material 124 to provide a friction force, such as a felt, is interposed between slip plate 121 an slip receiving part 122.

With the above configuration, in image pickup device driving apparatus 170 and imaging apparatus 101 in the second embodiment of the invention, when a user moves knob 12, movable unit 103 is rotated, and as a result, image pickup device 15 can be manually moved in the direction of optical axis. At this time, in driving unit 120, since a space between slip plate 121 and slip receiving part 122 is slipped, it is possible to move image pickup device 15 manually in the direction of optical axis without imposing load to stepping motor 129 of driving unit 120.

On the other hand, in image pickup device driving apparatus 170 and imaging apparatus 101 in the second embodiment of the invention, image pickup device 15 can be automatically moved in the direction of optical axis. When stepping motor 129 is rotated, slip receiving part 122 fixed on shaft 127 by means of screw 123 is rotated, and according to the rotation, gear 125 of slip plate 121 is rotated by a friction force of friction material 124. Accordingly, movable unit 103 is rotated, thereby moving image pickup device 15 in the direction of optical axis.

### Third Embodiment

Next, image pickup device driving apparatus 270 according to a third embodiment of the invention will be described.

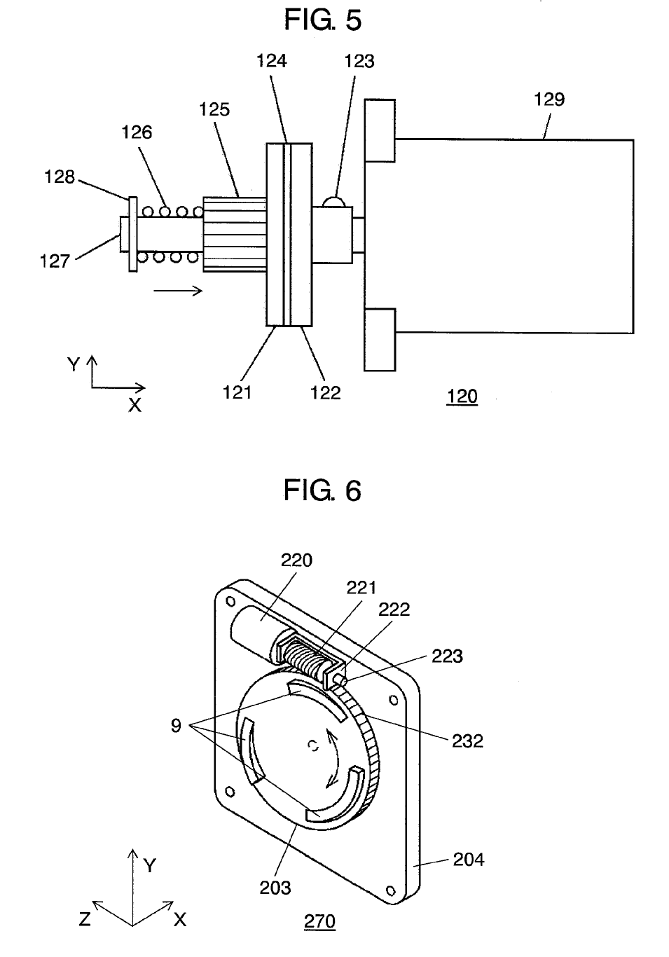

FIG. 6 is a view showing a configuration of image pickup device driving apparatus 270 according to a third embodiment of the invention. FIG. 6 shows movable unit 203 and driving unit 220 of image pickup device driving apparatus 270. Other components common to image pickup device driving apparatus 70 shown in FIG. 1 are denoted by like reference numerals, and explanation thereof will be omitted.

Referring to FIG. 6 showing the third embodiment of the invention, worm gear 221 attached to shaft 223 being rotated by driving unit 220 is used to rotate movable unit 203. Worm gear 221 is held on shaft 223 by holder 222 so that worm gear 221 is not deviated from shaft 223. In addition, driving part 220 is provided on a surface of base 204 on which movable unit 203 is placed, and shaft 223 of driving unit 220 is arranged on the outer circumference of movable unit 203.

In image pickup device driving apparatus 270 according to the third embodiment of the invention, worm gear 221 is rotated when driving unit 220 is rotated, and movable unit 203 is rotated by engaging a saw-toothed wheel provided in worm gear 221 with a saw-toothed wheel provided on the circumference of movable unit 203. As a result, image pickup device 15 attached to image pickup device holder 5 can be automatically moved in the direction of optical axis.

In image pickup device driving apparatus 270 according to the third embodiment of the invention, using worm gear 221 as a means for rotating movable unit 203 makes it possible to rotate movable unit 203 more smoothly since worm gear 221 contacts saw-toothed portion 232 provided on the circumference of movable unit 203 in a wider range. In addition, biasing worm gear 221 to movable unit 203 by means of elastic member or the like makes it possible to rotate movable unit 203 more smoothly.

If the rotation of movable unit 203 is to be stopped at a desired position, like the above, a stepping motor as driving unit 220 may be used to stop a magnetic core at a desired position, or a movable unit stopping unit such as a plunger as a separate mechanical position holding power providing member may be used to stop the rotation of movable unit 203, or image pickup device 15 may be stopped at any positions in the direction of optical axis by stopping movement of image pickup device holder 5 using an image pickup device holder stopper such as a plunger.

### Fourth Embodiment

Next, image pickup device driving apparatus 370 according to a fourth embodiment of the invention will be described.

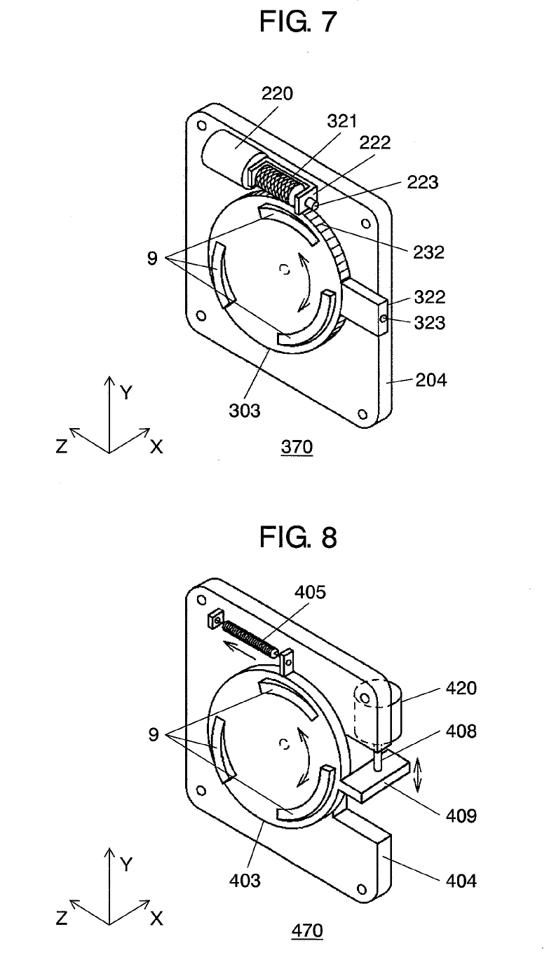

FIG. 7 is a view showing a configuration of image pickup device driving apparatus 370 according to a fourth embodiment of the invention. FIG. 7 shows movable unit 303 and driving unit 220 of image pickup device driving apparatus 370. Other components common to image pickup device driving apparatus 270 shown in FIG. 6 are denoted by like reference numerals, and explanation thereof will be omitted.

As shown in FIG. 7, image pickup device driving apparatus 370 according to the fourth embodiment of the invention is different from image pickup device driving apparatus 270 of the third embodiment of the invention in that, in the former, saw-toothed portion 232 formed in worm gear 321 is a two-line screw and movable unit 303 has projection 322 having female screw 323 to which knob 12 is attached.

With this configuration, in image pickup device driving apparatus 370 of the fourth embodiment of the invention, worm gear 321 is rotated when driving unit 220 is rotated, and, since worm gear 321 is biased to movable unit 303, movable unit 303 is rotated by engaging a saw-toothed wheel provided in worm gear 321 with a saw-toothed wheel provided on the circumference of movable unit 303. As a result, image pickup device 15 attached to image pickup device holder 5 can be automatically moved in the direction of optical axis.

In addition, in image pickup device driving apparatus 370 of the fourth embodiment of the invention, since a two-line screw is provided as a saw-toothed portion 232 of worm gear 321, it is possible to rotate worm gear 321 by rotating movable unit 303. Accordingly, in image pickup device driving apparatus 370 of the fourth embodiment of the invention, since movable unit 303 can be rotated by moving knob 12 manually, it is also possible to move image pickup device 15 manually in the direction of optical axis. Although it has been illustrate in the fourth embodiment that the saw-toothed wheel of worm gear 321 is the two-line screw, the invention is not limited to this, but encompasses all saw-toothed wheels that can rotate worm gear 321 by moving movable unit 303 manually. For example, a three or more-line screw may be used to rotate worm gear 321 by rotation of movable unit 303.

As described above, image pickup device driving apparatus 370 of the fourth embodiment of the invention which employs the simple configuration that worm gear 321 is used and the three or more-line screw is used as its saw-toothed wheel makes it possible to move image pickup device 15 either automatically or manually in the direction of optical axis.

### Fifth Embodiment

Next, image pickup device driving apparatus 470 according to a fifth embodiment of the invention will be described.

FIG. 8 is a view showing a configuration of image pickup device driving apparatus 470 according to a fifth embodiment of the invention. FIG. 8 shows movable unit 403 and driving unit 420 of image pickup device driving apparatus 470. Since other components are common to those of image pickup device driving apparatus 70 shown in FIG. 1, explanation thereof will be omitted.

As shown in FIG. 8, in the fifth embodiment of the invention, a direct-driven motor such as a linear actuator as driving unit 420 is used to rotate movable unit 403. Pressing member 409 pressed by shaft 408 of driving unit 420 is arranged at one end of movable unit 403. Movable unit 403 is biased toward one direction by means of elastic member 405. Movable unit 403 is attached to base 404.

In image pickup device driving apparatus 470 of the fifth embodiment of the invention, when shaft 408 of driving unit 420 presses pressing member 409, movable unit 403 can be rotated (in a clockwise direction in FIG. 8). On the other hand, by reducing a pressing force of shaft 408 of driving unit 420 to pressing unit 409 (i.e., inserting shaft 408 into pressing unit 409), movable unit 403 can be rotated in an opposite direction (a counterclockwise direction in FIG. 8).

Accordingly, in image pickup device driving apparatus 470 of the fifth embodiment of the invention, since movable unit 403 can be rotated with no need to provide a saw-toothed wheel on the circumference of movable unit 403, image pickup device 15 can be moved in the direction of optical axis.

If the rotation of movable unit 403 is to be stopped at a desired position, a stepping motor as driving unit 420 may be used to stop a magnetic core at a desired position, or a movable unit stopping unit such as a separate mechanical plunger may be used to stop the rotation of movable unit 403, or image pickup device 15 may be stopped at any positions in the direction of optical axis by stopping movement of image pickup device holder 5 using an image pickup device holder stopper such as a plunger.

### Sixth Embodiment

Next, image pickup device driving apparatus 570 according to a sixth embodiment of the invention will be described.

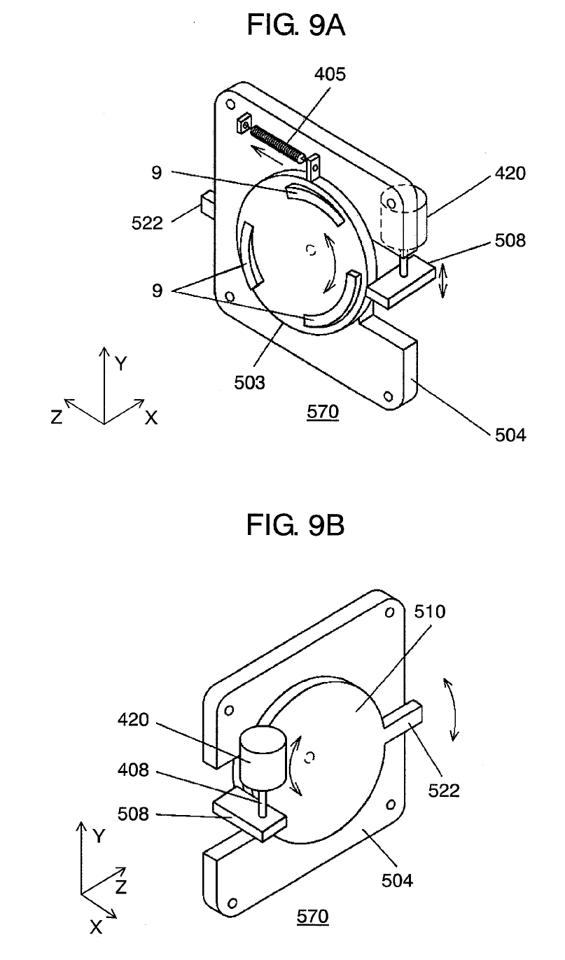

FIGS. 9A and 9B are views for explaining image pickup device driving apparatus 570 according to a sixth embodiment of the invention. FIG. 9A is a front perspective view showing a configuration of image pickup device driving apparatus 570 according to the sixth embodiment of the invention, and FIG. 9B is a rear perspective view showing a configuration of the image pickup device driving apparatus 570 according to the sixth embodiment of the invention.

FIGS. 9A and 9B show movable unit 503 and driving unit 420 of image pickup device driving apparatus 570. Other components common to image pickup device driving apparatus 470 shown in FIG. 8 are denoted by like reference numerals, and explanation thereof will be omitted.

As shown in FIGS. 9A and 9B, image pickup device driving apparatus 570 of the sixth embodiment of the invention is different from image pickup device driving apparatus 470 of the fifth embodiment of the invention in that, in the former, manual movable unit 510 having an axis common to movable unit 503 is arranged at a side opposite to a side at which movable unit 503 of base 504 is arranged, and driving unit 420 is attached to manual movable unit 510.

With this configuration, in image pickup device driving apparatus 570 of the sixth embodiment of the invention, driving unit 420 is driven to press pressing member 508, movable unit 503 is rotated to move image pickup device 15 automatically in the direction of optical axis. In addition, when projection 522 is manually operated to rotate manual movable unit 510, it is possible to move image pickup device 15 manually in the direction of optical axis.

### Seventh Embodiment

Next, image pickup device driving apparatus 670 according to a seventh embodiment of the invention will be described.

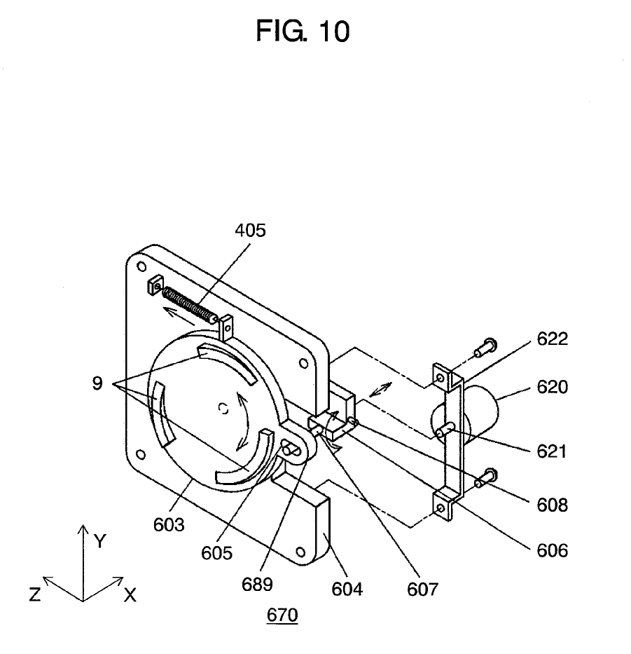

FIG. 10 is a view showing a configuration of image pickup device driving apparatus 670 according to a seventh embodiment of the invention. FIG. 10 shows movable unit 603 and driving unit 620 of image pickup device driving apparatus 670. Since other components are common to image pickup device driving apparatus 70 shown in FIG. 1, explanation thereof will be omitted.

As shown in FIG. 10, in the seventh embodiment of the invention, a direct-driven motor such as a linear actuator as driving unit 620 is used to rotate movable unit 603. Driving unit 620 is attached to a side opposite to a side at which movable unit 603 of base 604 is arranged, by means of attaching member 622. A biasing force applied from shaft 621 of driving unit 620 is changed in its direction by driving direction changing member 606 axially supported by shaft 608, and accordingly, shaft 607 of driving direction changing member 606 is moved in a Y axis direction. When shaft 607 of driving direction changing member 606 is moved in the Y axis direction, movable unit 603 is rotated. When movable unit 603 is rotated, image pickup device 15 can be moved in the direction of optical axis.

Bearing 605 of shaft 607 of driving direction changing member 606 is provided at projection 689 provided at one end of movable unit 603. Since a position at which shaft 607 contacts bearing 605 is moved in a Z axis direction when a leading end of shaft 607 is moved in the Y axis direction, bearing 605 is set as a hole extending in the Z axis direction.

As described above, in image pickup device driving apparatus 670 of the seventh embodiment of the invention, when driving unit 620 is driven, image pickup device 15 can be automatically moved in the direction of optical axis. In addition, in image pickup device driving apparatus 670 of the seventh embodiment of the invention, since the direction of the biasing force given by shaft 621 of driving unit 620 is changed by driving direction changing member 606 and then applied to movable unit 603, it is possible to raise a degree of freedom in arrangement of driving unit 620. For example, in the example shown in FIG. 10, driving unit 620 is arranged such that shaft 621 directs to the X axis direction, which is effective for a case where there is no space for arrangement in the Y axis direction.

If the rotation of movable unit 603 is to be stopped at a desired position, a stepping motor as driving unit 620 may be used to stop a magnetic core at a desired position, or a movable unit stopping unit such as a separate mechanical plunger may be used to stop the rotation of movable unit 603, or image pickup device 15 may be stopped at any positions in the direction of optical axis by stopping movement of image pickup device holder 5 using an image pickup device holder stopper such as a plunger.

### Eighth Embodiment

Next, image pickup device driving apparatus 770 according to an eighth embodiment of the invention will be described.

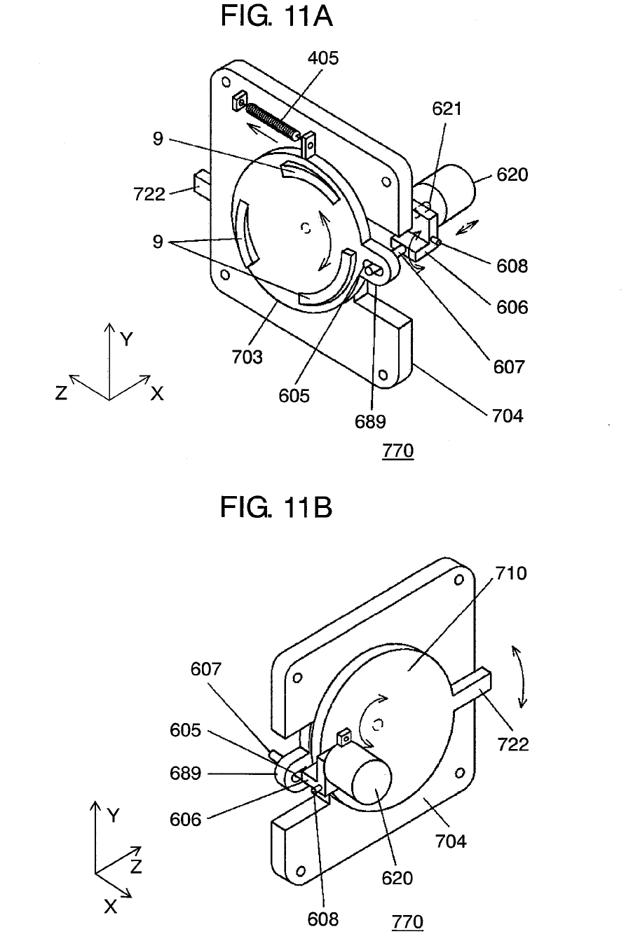

FIGS. 11A and 11B are views for explaining image pickup device driving apparatus 770 according to an eighth embodiment of the invention. FIG. 11A is a front (lens 191 side) perspective view showing a configuration of image pickup device driving apparatus 770 according to the eighth embodiment of the invention, and FIG. 11B is a rear perspective view showing a configuration of the image pickup device driving apparatus 770 according to the eighth embodiment of the invention.

FIGS. 11A and 11B show movable unit 703 and driving unit 620 of image pickup device driving apparatus 770. Other components common to image pickup device driving apparatus 670 shown in FIG. 10 are denoted by like reference numerals, and explanation thereof will be omitted.

As shown in FIGS. 11A and 11B, image pickup device driving apparatus 770 of the eighth embodiment of the invention is different from image pickup device driving apparatus 670 of the seventh embodiment of the invention in that, in the former, manual movable unit 710 having an axis common to movable unit 703 is arranged at a side opposite to a side at which movable unit 703 of base 704 is arranged, and driving direction changing member 606 and driving unit 620 are attached to manual movable unit 710.

With this configuration, in image pickup device driving apparatus 7700 of the eighth embodiment of the invention, driving unit 620 is driven to rotate movable unit 703 to move image pickup device 15 automatically in the direction of optical axis. In addition, when projection 722 is manually operated to rotate manual movable unit 710, it is possible to move image pickup device 15 manually in the direction of optical axis.

### Ninth Embodiment

Next, image pickup device driving apparatus 870 and imaging apparatus 801 according to a ninth embodiment of the invention will be described.

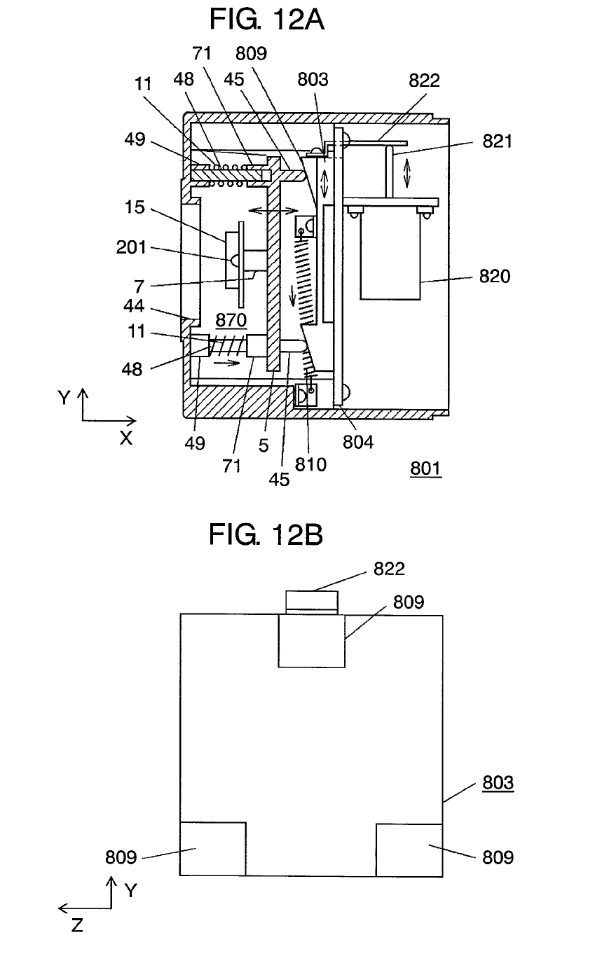

FIGS. 12A and 12B are views for explaining image pickup device driving apparatus 870 and imaging apparatus 801 using the same according to a ninth embodiment of the invention. As shown in FIGS. 12A and 12B, image pickup device driving apparatus 870 and imaging apparatus 801 according to the ninth embodiment of the invention are different from the image pickup device driving apparatuses and the imaging apparatuses according to the first to eighth embodiments of the invention in that, in the former, image pickup device holder 5 is moved in the direction of optical axis (X axis direction in FIGS. 12A and 12B) as movable unit 803 does not press image pickup device holder 5 by being rotated, but is moved in a parallel direction (Y axis direction in FIGS. 12A and 12B).

In image pickup device driving apparatus 870 and imaging apparatus 801 using the same according to the ninth embodiment of the invention, a direct-driven motor is used as driving unit 820 is used, and driving unit 820 is attached to a side opposite to a side at which image pickup device 15 of base 804 is arranged. Movable unit 803 is arranged at a side at which image pickup device holder 5 of base 804 is arranged, and is movably arranged in a predetermined direction (Y axis direction in FIGS. 12A and 12B).

FIG. 12B is a view showing a configuration of movable unit 803 used in image pickup device driving apparatus 870 according to the ninth embodiment of the invention. As shown in FIG. 12B, movable unit 803 of the ninth embodiment of the invention includes three slopes 809 provided to contact three projections 45 of image pickup device holder 5, and biasing force transmitting member 822 that moves movable unit 803 using a biasing force given by shaft 821 of driving unit 820. Three slopes 809 are arranged with the same shape in the same direction, and are configured to increase in height in the Y axis direction in FIG. 12B in the ninth embodiment of the invention.

In the ninth embodiment of the invention, movable unit 803 remains biased toward a predetermined direction (−Y axis direction in FIGS. 12A and 12B) by means of elastic member 810 having elasticity, such as a helical spring. When driving unit 820 is driven, its shaft 821 is moved in the Y axis direction in FIGS. 12A and 12B, and thus, biasing force transmitting member 822 provided in movable unit 803 is pressed. As a result, movable unit 803 is moved in the Y axis direction in FIGS. 12A and 12B. In the example shown in FIG. 12A, as shaft 821 of driving unit 820 is moved in the Y axis direction, movable unit 803 is moved in the Y axis direction. As a result, the position at which three slopes 809 of movable unit 803 contact projections 45 of image pickup device holder 5 is changed, and image pickup device holder 5 is moved in the X axis direction. On the contrary, when shaft 821 of driving unit 820 is moved in the −Y axis direction, image pickup device holder 5 is moved in a −X axis direction.

In this manner, in image pickup device driving apparatus 870 and imaging apparatus 801 according to the ninth embodiment of the invention, when driving unit 820 is driven, it is possible to move image pickup device 15 automatically in the direction of optical axis.

As shown in FIG. 12A, in image pickup device driving apparatus 870 and imaging apparatus 801, when moving manually image pickup device 15 in the direction of optical axis is desired, image pickup device 15 can be manually moved in the direction of optical axis by moving driving unit 820 manually, with driving unit 820 slidable relative to base 804 in the Y axis direction in FIGS. 12A and 12B.

It is possible to construct a monitoring camera apparatus using image pickup device driving apparatuses and the imaging apparatuses using the same in the above-described embodiments of the invention.

In detail, the image pickup device driving apparatus is applied to a monitoring camera apparatus that takes a photograph of a color image in a visible light region in bright surroundings by arranging an infrared cut filter on an optical axis, while taking a photograph of a monochrome image using a light ray having a wavelength including an infrared ray region in dark surroundings by removing the infrared cut filter arranged on the optical axis. In such a monitoring camera apparatus, since the infrared cut filter is arranged on the optical axis or removed therefrom depending on change of illumination and wavelengths of light used for photographing are different, an optical path is changed, and accordingly, an optimal focusing position between a lens and an image pickup surface on which a photoelectric converting element is arranged in an image pickup device is changed. When a controller drives a driving unit in arrangement or removal of the infrared cut filter using the image pickup device driving apparatuses of the embodiments, it is possible to automatically set the image pickup device to be in a position having the highest focusing value in the direction of optical axis, thereby obtaining a focused sharp image irrespective of ambient brightness.

Although it has been illustrated in the above embodiments of the invention that three projections are provided in the image pickup device holder holding the image pickup device and there slopes corresponding to the three projections are provided in the movable unit, the image pickup device driving apparatus and the imaging apparatus of the invention are not limited to this configuration. For example, three slopes may be arranged at the image pickup device holder and three projections may be provided in the movable unit.

Although it has been illustrated in the above embodiments of the invention that the image pickup device holder holding the image pickup device is provided at the side of lens unit and the movable unit is arranged at the side opposite to the side of lens unit, in the image pickup device holder, the image pickup device driving apparatus and the imaging apparatus of the invention are not limited to this configuration. For example, the movable unit may be arranged at the side of lens unit and the image pickup device holder may be arranged at the side of lens unit and the side opposite to the movable unit. In this case, it is required to prepare a hole through which a light ray passes, at the vicinity of the center of the movable unit.

The image pickup device driving apparatus and the imaging apparatus of the invention are not limited in use to monitoring camera apparatuses, but, for example, may be applied to all imaging apparatuses known in the art, such as a video camera, a digital camera and so on.

### INDUSTRIAL APPLICABILITY

As apparent from the above description, the image pickup device driving apparatus and the imaging apparatus of the invention have an advantage in that an image pickup device can be smoothly moved in an optical axis direction even by a relatively weak driving force, and the image pickup device can be stopped at a desired position even when an external force such as impact is applied to the image pick device. The image pickup device driving apparatus and the imaging apparatus of the invention are useful for imaging apparatuses such as monitoring camera apparatuses, video camera apparatuses and so on, in particular, in moving an image pickup device in an optical axis direction of a lens unit.

1. An image pickup device driving apparatus comprising:
an image pickup device holder that holds an image pickup device, with an image pickup surface of the image pickup device directing to a predetermined direction, and is movable in a direction of optical axis;
a movable unit that is provided to contact the image pickup device holder;
a driving unit that moves the image pickup device held by the image pickup device holder in the direction of optical axis by driving the movable unit, with a surface direction of the image pickup surface unchanged; and
a position holding power providing member that provides position holding power to hold a position of the image pickup device holder in the direction of optical axis.

2. The image pickup device driving apparatus of claim 1,
wherein the image pickup device holder includes three projections on a surface facing the removable unit,
wherein the removable unit includes three slopes on a surface facing the image pickup device holder, the three slopes contacting the three projections of the image pickup device holder respectively, and
wherein the image pickup device is moved in the direction of optical axis as a distance in the direction of optical axis between the image pickup device holder and the movable unit is changed when the driving unit moves the movable unit.

3. The image pickup device driving apparatus of claim 2,
wherein the driving unit is a stepping motor, and
wherein the position holding power providing member is a magnetic core position fixing member that fixes a position of a magnetic core in the stepping motor.

4. The image pickup device driving apparatus of claim 2,
wherein the position holding power providing member is a movable unit stopper that stops operation of the movable unit mechanically.

5. The image pickup device driving apparatus of claim 2,
wherein the position holding power providing member is an image pickup device holder stopper that stops movement of the image pickup device holder in the direction of optical axis.

6. The image pickup device driving apparatus of claim 2, further comprising an elastic member that biases the image pickup device holder toward one of the direction of optical axis,
wherein the movable unit applies a biasing force to the image pickup device holder in a direction opposite to the one of the direction of optical axis.

7. The image pickup device driving apparatus of claim 2,
wherein the movable unit has a shaft provided in the direction of optical axis and is axially and rotatably supported by the shaft, and
wherein the driving unit changes the distance between the movable unit and the image pickup device holder by rotating the movable unit to change positions at which the three projections contact the three slopes.

8. The image pickup device driving apparatus of claim 7,
wherein the driving unit is a rotary motor.

9. The image pickup device driving apparatus of claim 8,
wherein the driving unit has a worm gear that rotates the movable unit.

10. The image pickup device driving apparatus of claim 9,
wherein the worm gear has a two or more-line screw.

11. The image pickup device driving apparatus of claim 8,
wherein the driving unit has a parallel axis saw-toothed wheel that rotates the movable unit.

12. The image pickup device driving apparatus of claim 8,
wherein the driving unit has a helical gear that rotates the movable unit.

13. The image pickup device driving apparatus of claim 11,
wherein a slip plate is interposed between the parallel axis saw-toothed wheel and the rotary motor.

14. The image pickup device driving apparatus of claim 7,
wherein the movable unit has a knob that rotates the movable unit manually.

15. The image pickup device driving apparatus of claim 7,
wherein the driving unit is a direct-driven motor.

16. The image pickup device driving apparatus of claim 14,
wherein a driving direction changing member that changes a driving direction is interposed between the direct-driven motor and the movable unit.

17. The image pickup device driving apparatus of claim 2,
wherein the movable unit is movable in a direction perpendicular to the direction of optical axis, and
wherein the driving unit changes the distance between the movable unit and the image pickup device holder by moving the movable unit in the direction perpendicular to the direction of optical axis to change positions at which the three projections contact the three slopes.

18. The image pickup device driving apparatus of claim 17,
wherein the driving unit is a direct-driven motor.

19. An imaging apparatus comprising:
a lens unit;
an image pickup device;
an image pickup device driving apparatus of claim 2, and
an image signal processing unit that performs an image signal process for a signal outputted from the image pickup device.
